(19) United States
(12) Patent Application Publication
(10) Pub. No.: US 2011/0101630 A1
(43) Pub. Date: May 5, 2011

(54) BEND SHAPE FOR ANTI-ROLL BAR

(76) Inventors: Tadashi Sakai, Wixom, MI (US); Shinichi Nishizawa, Walled Lake, MI (US); Akitoshi Hamamoto, Bowling Green, KY (US)

(21) Appl. No.: 12/612,026

(22) Filed: Nov. 4, 2009

(51) Int. Cl. B60G 21/055; B21D 31/00

(52) U.S. Cl. 280/5.506; 72/362; 280/124.107

(57) ABSTRACT

A method of reducing peak stress and distributing stress experienced in bends of anti-roll bars that involves configuring the shape of the bends so that they do not have uniform radii of curvature. Generally the shapes of the bends have greater radii of curvature at central portions than other portions of the bends. Also the shapes of the bends may be symmetrical or non-symmetrical. According to one embodiment the shapes of the bends include a combination of curved and straight portions.

### BACKGROUND

Shape of anti-roll bars for automobile suspension systems are usually designed from a standpoint of avoiding physical interference with other components mounted on the bottom of a vehicle. Also the diameter of the bar is usually pre-selected and fixed to achieve a desired anti-roll stiffness. By setting a limit or limits to the shape (to avoid interference with other components) and fixing the diameters of the anti-roll bars there is little design flexibility to allow engineers/designers to adjust the resultant stress a given anti-roll bar will experience in use.

One well known method for reducing stress in anti-roll bars involves increasing the radius of bent portions of the anti-roll bars. However, this approach is not always possible when interference of other components becomes an issue or when clamping position of the anti-roll bars is difficult to change.

In order to improve the durability of anti-roll bars, there have been a couple of conventional approaches as follows: 1) Material approach: use of high strength material(s) and materials having high hardness; and 2) Manufacturing approach: use of efficient shot peening process that will create a compressive residual stress layer that will resist surface cracking.

The present invention provides a new design approach to fabricating anti-roll bars which involves slightly modifying the bend shape of the anti-roll bars.

### BRIEF SUMMARY

According to one embodiment the present invention provides an anti-roll bar for a vehicle suspension system which comprises at least one bend having a non-constant radius which reduces peak stresses applied to the at least one bend.

The present invention further provides a suspension system for a vehicle which comprises an anti-roll bar having at least one bend having a non-constant radius which reduces peak stresses applied to the at least one bend.

The present invention also provides a method of reducing peak stress in bends of anti-roll bars which method comprises configuring bends in anti-roll bars so that the bends do not have constant radii of curvature.

### BRIEF DESCRIPTION OF THE DRAWINGS

The present invention will be described with reference to the attached drawings which are non-limiting examples only, in which:

FIG. 1 is an example of the maximum principal stress distribution for a simple shaped anti-roll bar.

FIG. 2 is an example of the maximum principal stress distribution for an anti-roll bar having compound bends.

FIG. 3 compares the shapes of the shoulder portion center lines of a constant radius bend (top curve) and a non-constant radius bend (lower curve).

FIGS. 4A and 4B are contour comparisons of the maximum principal stress of a bar having a constant radius bend (FIG. 4A) and a non-constant radius bend (FIG. 4B).

FIG. 5 is a diagram that compares the maximum principal stress distribution along the shoulder of a bar having a constant radius bend (the curve which reaches the highest point) and a non-constant radius bend (the curve with the substantially flat center).

FIG. 6 compares the shapes of the shoulder portion center lines of a constant radius bend (top curve) and a bend formed by a combination of curved and straight portions (lower curve).

FIGS. 7A and 7B are contour comparisons of the maximum principal stress of a bar having a constant radius bend (FIG. 7A) and a bend formed by a combination of curved and straight portions (FIG. 7B).

FIG. 8 is a diagram that compares the maximum principal stress distribution along the shoulder of a bar having a constant radius bend (the curve which reaches the highest point) and a bend formed by a combination of curved and straight portions (the curve with the more flattened center).

### DETAILED DESCRIPTION OF THE DRAWINGS AND THE PRESENTLY PREFERRED EMBODIMENTS

The present invention is directed to a method of configuring and fabricating anti-roll bars so that stresses experienced under load are distributed and maximum stresses are reduced or smoothed out. This distribution and reduction of stresses allows the resulting anti-roll bars have extended useful product lives as compared to prior art anti-roll bars.

Anti-roll bars are coupled to vehicle suspension systems near opposite ends of the anti-roll bars by clamps. By convention, the first bends that are formed in anti-roll bars outside of the clamps are referred to as “shoulder bends.” Accordingly reference herein to shoulder bend identifies the first bends that are formed in anti-roll bars outside of the clamps. Some anti-roll bars include substantially straight central portions between their shoulder bends. Other anti-roll bars can have multiple bends between and/or outside of their shoulder bends. Although peak stresses can develop along shoulder bends, other in some configurations peak stresses can develop in bend portions other than shoulder bends. Accordingly, while reference and discussion is made herein to shoulder bends, the manner of designing bends in anti-roll bars is not limited only to shoulder bends, but is rather applicable to any bend(s) that experience stresses that can be reduced or distributed according to the present invention.

According to the present invention bent areas that are formed in the anti-roll bars do not have a constant radius of curvature. This approach departs from traditional anti-roll bars in which of the bent areas have constant radii. During the course of the present invention it was discovered that the peak stress values which usually develop at the bends of conventional anti-roll bars (having constant radius bends) when the anti-roll bars are deformed can be distributed so as to reduce the peak stress values.

In order to evaluate and study the relationship of stress distribution to bend shapes of anti-roll bars various bend shapes of anti-roll bars were tested and bend shapes were changed to determine how shape changes effected stress distribution of anti-roll bars.

The procedure followed during the course of the present invention to determine optimal bend shapes for stress reduction involved expressing bend shapes experimentally as Bezier curves with five control points. For a given initial curve, three control points are independently readjusted within a certain position range while two control points are fixed so as to maintain a continuity of the bar shape (e.g., limited by manufacturability), so that thousands of bend shapes can be created and subjected to loads. Following this approach the best shape which minimizes the peak stress can be determined via finite element analysis (FEA). This procedure proved that the maximum stresses on the bend of an anti-roll bar can be reduced if the bend shape is not in the shape of a partial circle, i.e. does not have a constant radius of curvature. This discovery runs against the conventional use of constant radius dies about which anti-roll bars are conventionally bent.

Whereas the present invention provides bent shapes for portions of anti-roll bars that distribute and reduced areas of high stress, the actual manner of fabricating and bending the bars involves substantially conventional technologies such as bending dies. Howbeit the use of appropriately shaped dies, such as dies that do not have a constant radius are used according to the present invention. Likewise, other machinery or apparatus that are used to bend bars can be similarly modified to form bends that do not have constant radii or continuous bends.

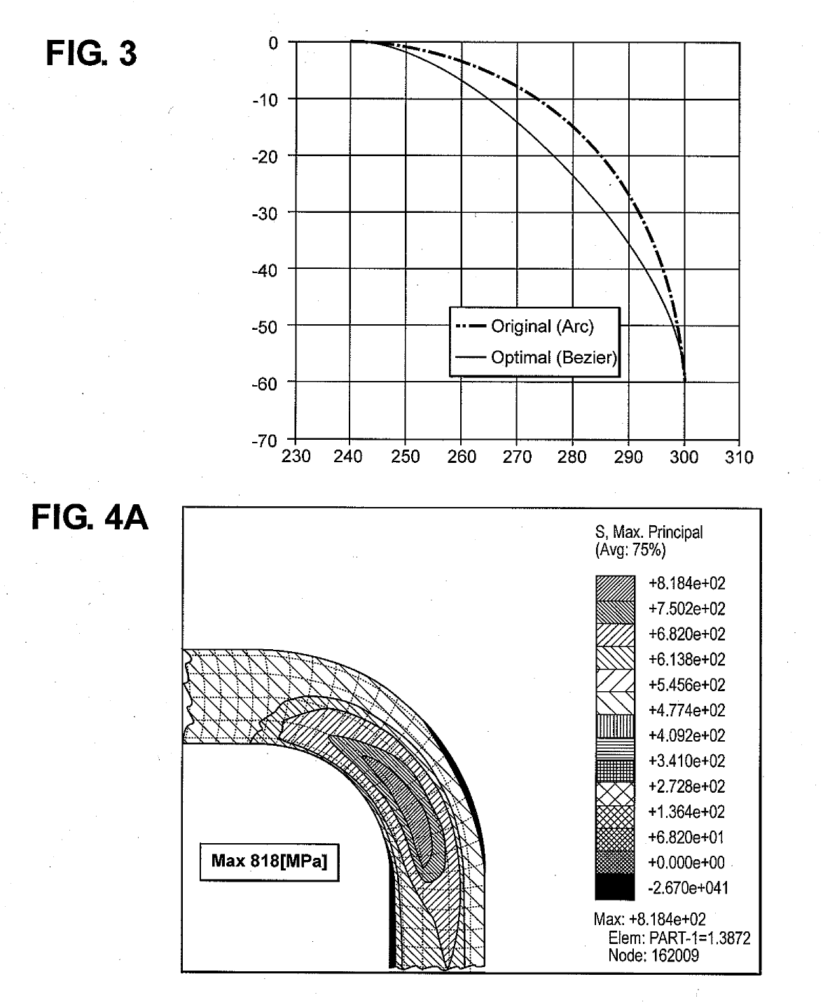

FIG. 3 compares the shapes of the shoulder portion center lines of a bar having a constant radius bend (top curve) and a non-constant radius bend (lower curve). The coordinates in FIG. 3 are in millimeters and provide dimensional references. The constant radius of curvature of the conventional bend is readily apparent from the coordinates and has a radius of 60 mm. The non-constant radius or “optimized” bend shape shown in FIG. 3 has a larger radius of curvature around high stress area, which is normally around the middle of the bend, and smaller radii of curvature at both ends of the bend. In other embodiments in which bars might experience higher stress at the ends of a bend portion (not the center) the center portion of the bend can be provided with a smaller radius of curvature and the end portions can be provided with larger radii of curvature according to the present invention. Thus the bend shapes of the present invention are best described as having non-constant radii.

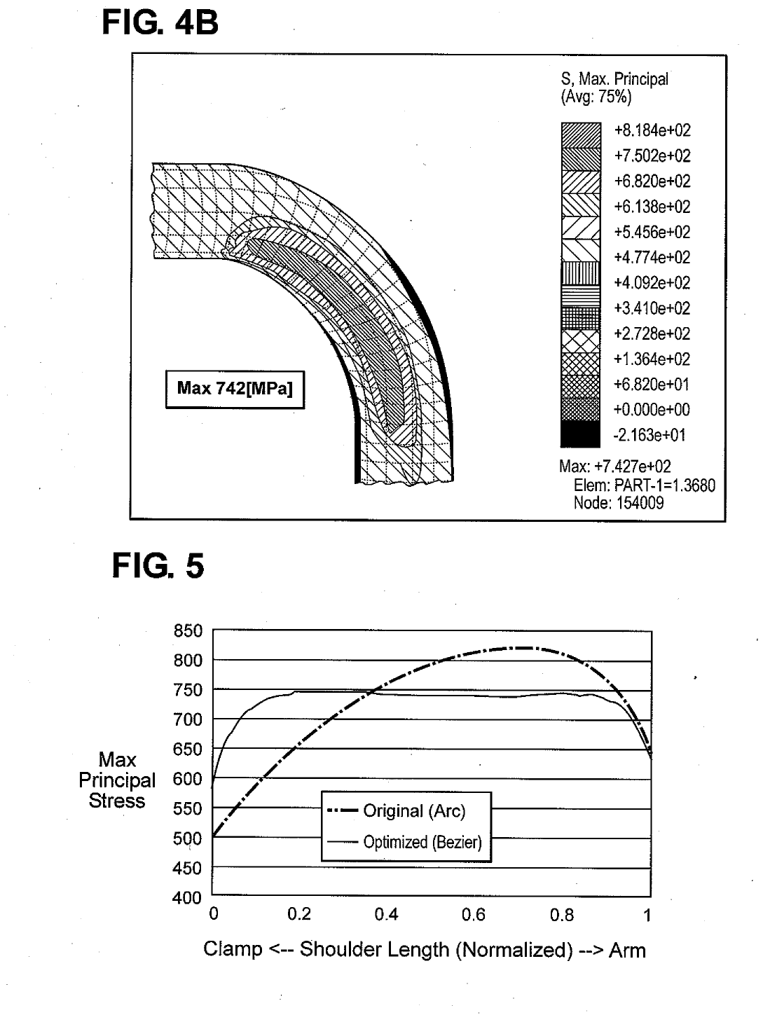

FIGS. 4A and 4B are contour comparisons of the maximum principal stress of a bar having a constant radius bend (FIG. 4A) and a non-constant radius bend (FIG. 4B). As seen by comparing FIGS. 4A and 4B, the peak stress value around the middle of the bend can be reduced by flattening the stress distribution throughout the bend by optimally adjusting the curvature distribution on the bend. In this regard, the maximum peak stress value for the constant radius bend (FIG. 4A) was 818 MPa whereas the maximum peak stress value for the non-constant radius bend (FIG. 4B) was 742 MPa in the illustrated examples.

FIG. 5 is a diagram that compares the maximum principal stress distribution along the shoulder of a bar having a constant radius bend (the curve which reaches the highest point) and a non-constant radius bend (the curve with the substantially flat center). As seen in FIG. 5 whereas the stress in the bar having a constant radius forms a definite peak area, the stress in the bar having the non-constant radius has a substantially flat central areas where the stress is evenly distributed so that there is no peak stress area. FIG. 5 thus demonstrates the results of the present invention.

According to another embodiment of the present invention it was discovered that bent shapes in which adjacent portions have different radii of curvature also can be used to distribute and reduced areas of high stress

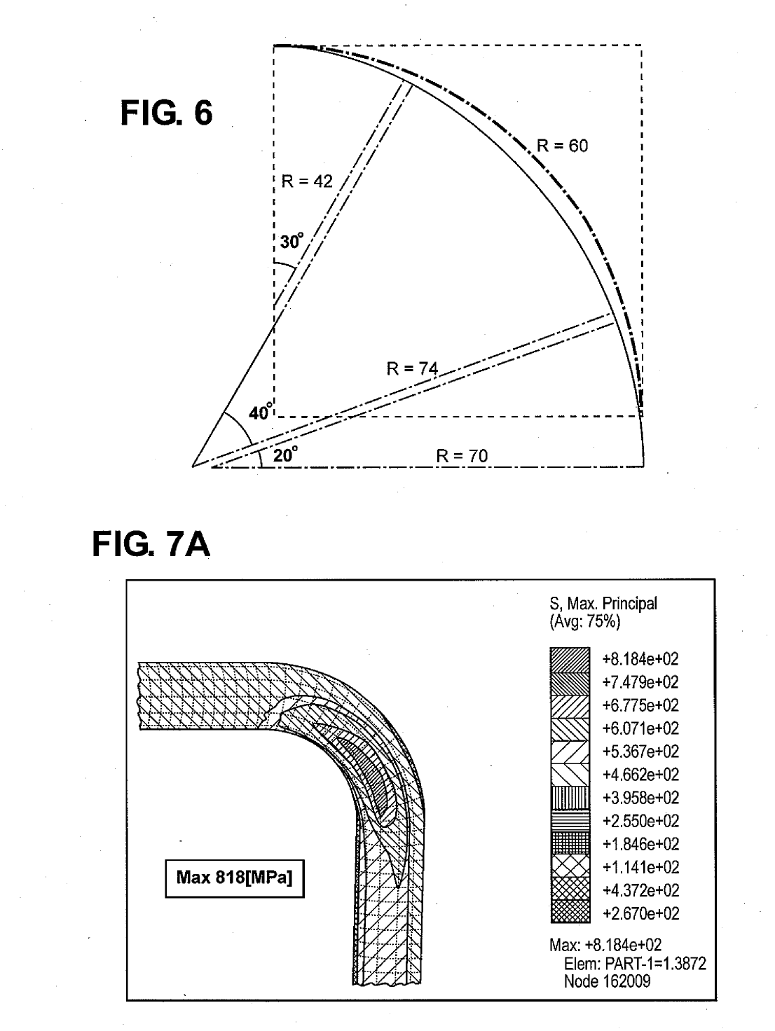

FIG. 6 compares the shapes of the shoulder portion center lines of a constant radius bend (top curve) and a bend formed by a combination of curved and straight portions (lower curve). In the illustrated embodiment the central portion of the bend has a radius of curvature that is 74 mm, a side portion that has a radius of curvature that is 42 mm and an opposite side portion that has a radius of curvature of 70 mm. Between these portions that have different radii of curvature are very small straight portions that are not bent. However existence of the straight portions between constant radii portions is not always necessary to mimic the optimal bend curve shape according to the present invention. Moreover, to mimic the optimal bend curve shape with a combination of curves and straight portions will allow the use of conventional bending machines which are designed to only form bends with constant radii which would otherwise have to be modified to produce the non-constant radii bends discussed above.

The constant radius bend of the conventional bend shown in FIG. 6 has a radius of curvature of 60 mm. The curve or bend formed by the combination of curved and straight portions or “optimized” bend shape has a larger radius of curvature around high stress area, which is normally around the middle of the bend, and smaller radii of curvature at both ends of the bend.

It is noted that overall shape of the bend formed by a combination of curved and straight portions in FIG. 6 is non-symmetrical. However, in other embodiments, the bends can be symmetrical. Further it is noted that a bend formed by a combination of curved and straight portions, in which the radii of curvature of the curved portions are each constant can be formed using bending machines that support only constant radius distribution.

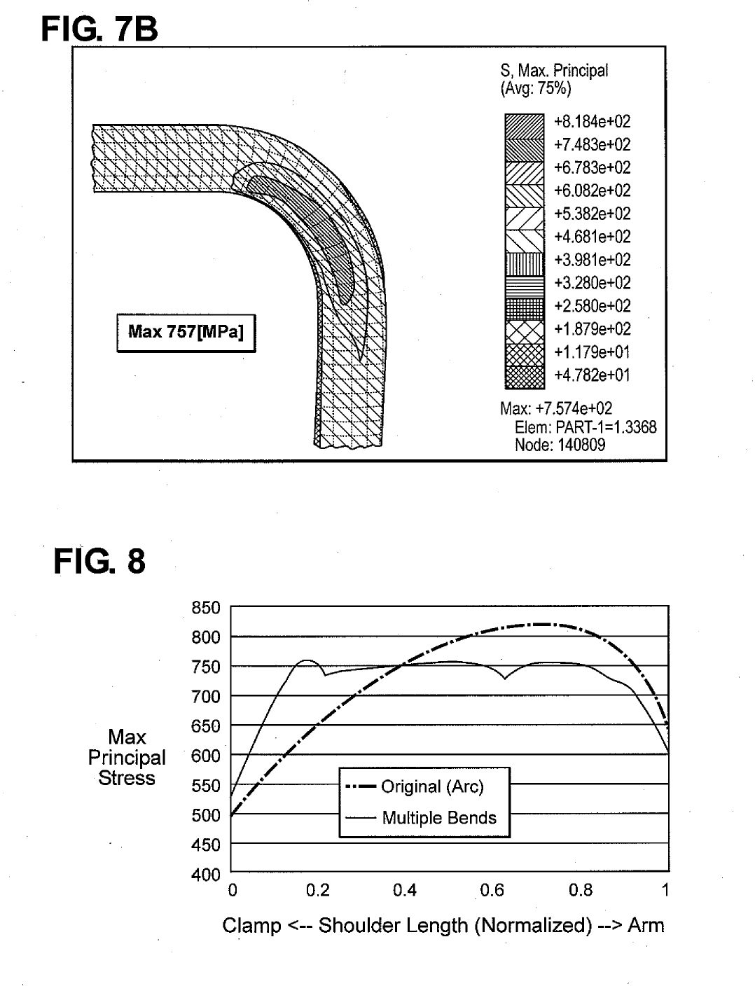

FIGS. 7A and 7B are contour comparisons of the maximum principal stress of a bar having a constant radius bend (FIG. 7A) and a bend formed by a combination of curved and straight portions (FIG. 7B). As seen by comparing FIGS. 7A and 7B, the peak stress value around the middle of the bend can be reduced by flattening the stress distribution throughout the bend by optimally adjusting the curvature distribution on the bend. In this regard, the maximum peak stress value for the constant radius bend (FIG. 7A) was 818 MPa whereas the maximum peak stress value for the bend formed by a combination of curved and straight portions (FIG. 7B) was 757 MPa in the illustrated examples.

FIG. 8 is a diagram that compares the maximum principal stress distribution along the shoulder of a bar having a constant radius bend (the curve which reaches the highest point) and a bend formed by a combination of curved and straight portions (the curve with the more flattened center). As seen in FIG. 8 whereas the stress in the bar having a constant radius forms a definite peak area, the stress in the bar having a combination of bent and straight portions has a substantially flat central areas where the stress is evenly distributed so that there is no peak stress area. FIG. 8 thus demonstrates the results of the present invention in the same manner essentially as FIG. 5.

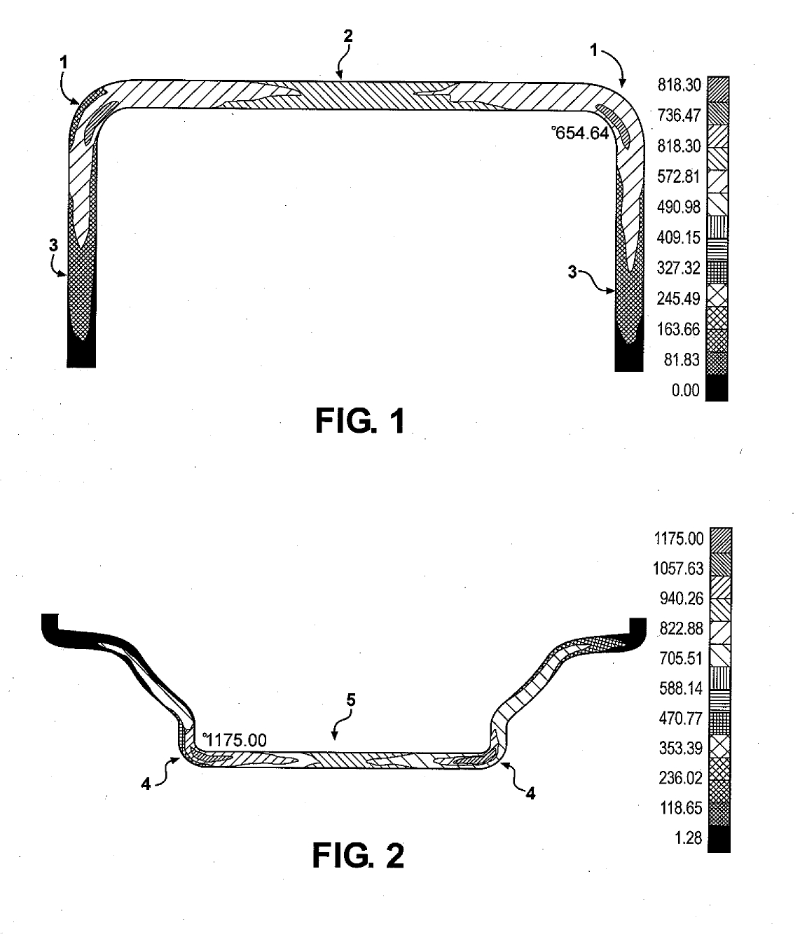

The bent portions of the anti-roll bars discussed herein are the shoulder bends. In a simple shaped anti-roll bar as shown in FIG. 1, there are two shoulder bends 1 on the opposite ends of the straight central portion 2, with arms extending 3 extending from the shoulder bends. For an anti-roll bar having compound bends as shown in FIG. 2, the shoulder bends are the first pair of bend 4 on the opposite ends of the straight central portion 5.

Other embodiments that are encompassed by the reference to non-constant radii include bends that have middle portions with radii of curvature that are larger or smaller than one or more side or adjacent portions. Further a non-constant bend can comprise two or more portions that have different radii of curvature and are not limited to the non-limited example shown in FIG. 6 or any of the figures.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

1. An anti-roll bar for a vehicle suspension system which comprises at least one bend having a non-constant radius which at least one bend is configured so as to reduce peak stresses applied to the at least one bend when a load is applied to the anti-roll bar.

2. The anti-roll bar for a vehicle suspension system according to claim 1, wherein at least one end of the bend extends from an adjacent straight portion.

3. The anti-roll bar for a vehicle suspension system according to claim 1, wherein the at least one bend comprises multiple arcs, at least two of which have different radii.

4. The anti-roll bar for a vehicle suspension system according to claim 1, wherein the at least one bend is symmetrical.

5. The anti-roll bar for a vehicle suspension system according to claim 1, wherein the at least one bend is non-symmetrical.

6. The anti-roll bar for a vehicle suspension system according to claim 1, wherein the at least one bend comprises a central portion with a radius of curvature and side portions with radii of curvature wherein the radius of curvature of the central portion is larger than the radii of curvature of at least one of the side portions.

7. The anti-roll bar for a vehicle suspension system according to claim 1, wherein the at least one bend comprises a central portion with a radius of curvature and side portions with radii of curvature wherein the radius of curvature of the central portion is smaller than the radii of curvature of at least one of the side portions.

8. A suspension system for a vehicle which comprises an anti-roll bar having at least one bend having a non-constant radius which at least one bend is configured so as to reduce peak stresses applied to the at least one bend when a load is applied to the anti-roll bar.

9. The suspension system for a vehicle according to claim 8, wherein at least one end of the bend extends from an adjacent straight portion.

10. The suspension system for a vehicle according to claim 9, wherein the at least one bend comprises multiple arcs, at least two of which have different radii.

11. The suspension system for a vehicle according to claim 9, wherein the at least one bend is symmetrical.

12. The suspension system for a vehicle according to claim 9, wherein the at least one bend is non-symmetrical.

13. The suspension system for a vehicle according to claim 9, wherein the at least one bend comprises a central portion with a radius of curvature and side portions with radii of curvature wherein the radius of curvature of the central portion is larger than the radii of curvature of at least one of the side portions.

14. The suspension system for a vehicle according to claim 9, wherein the at least one bend comprises a central portion with a radius of curvature and side portions with radii of curvature wherein the radius of curvature of the central portion is smaller than the radii of curvature of at least one of the side portions.

15. A method of reducing peak stress in bends of anti-roll bars which method comprises configuring bends in anti-roll bars so that the bends do not have constant radii of curvature.

16. The method according to claim 15, wherein the bends are configured to be symmetrical.

17. The method according to claim 15, wherein the bends are configured to be non-symmetrical.

18. The method according to claim 15, wherein at least one of the bends comprises a central portion with a radius of curvature and side portions with radii of curvature wherein the radius of curvature of the central portion is larger than the radii of curvature of at least one of the side portions.

19. The method according to claim 15, wherein at least one of the bends comprises a central portion with a radius of curvature and side portions with radii of curvature wherein the radius of curvature of the central portion is smaller than the radii of curvature of at least one of the side portions.

20. The anti-roll bar for a vehicle suspension system according to claim 1, wherein the anti-roll bar is a solid bar.

21. The anti-roll bar for a vehicle suspension system according to claim 8, wherein the anti-roll bar is a solid bar.

22. The method of reducing peak stress in bends of anti-roll bars according to claim 15 which method comprises configuring bends in solid anti-roll bars.
